(19) United States
(12) Patent Application Publication
(10) Pub. No.: US 2017/0361701 A1
(43) Pub. Date: Dec. 21, 2017

(54) SHUTTER WITH TRACK-GUIDED LOUVERS

(71) Applicant: GM GLOBAL TECHNOLOGY OPERATIONS LLC, Detroit, MI (US)

(72) Inventors: Brian C. Dunty, Sterling Heights, MI (US); Timothy M. McIntyre, Beverly Hills, MI (US)

(73) Assignee: GM GLOBAL TECHNOLOGY OPERATIONS LLC, Detroit, MI (US)

(21) Appl. No.: 15/188,387

(22) Filed: Jun. 21, 2016

(51) Int. Cl. B60K 11/08; B60R 19/52

(52) U.S. Cl. CPC B60K 11/085; B60R 19/52

(57) ABSTRACT

A shutter system for controlling a flow of an incident airstream through a grille opening in a vehicle includes a track arranged transverse to the airstream. The shutter system also includes a plurality of louvers configured to shift along the track and be guided thereby. The shutter system additionally includes a mechanism configured to select a position for the shutter system between and inclusive of fully-opened and fully-closed to regulate the flow of the incident airstream through the grille opening by shifting the plurality of louvers along the track. Each of the plurality of louvers is arranged along a plane transverse to the incident airstream and remains therein as the position of the shutter system is selected between and inclusive of fully-opened and fully-closed.

### TECHNICAL FIELD

The disclosure relates to a shutter assembly having track-guided louvers for controlling and directing an airstream.

### BACKGROUND

A shutter is typically a solid and stable covering for an opening. A shutter frequently consists of a frame and louvers or slats mounted within the frame.

Louvers may be fixed, i.e., having a permanently set position with respect to the frame. Louvers may also be operable, i.e., adjustable with respect to the frame for permitting a desired amount of light, air, and/or liquid to pass from one side of the shutter to the other. Depending on the application and the construction of the frame, shutters can be mounted to fit within, or to overlap the opening. In addition to various functional purposes, particularly in architecture, shutters may also be employed for largely ornamental reasons.

In motor vehicles, a shutter may be employed to control and direct a stream of air to various vehicle compartments and/or subsystems. Particularly, a shutter may be positioned at the front of the vehicle and employed to cool a vehicle's powertrain, as well as enhance comfort of vehicle passengers.

### SUMMARY

A shutter system for controlling a flow of an incident airstream through a grille opening in a vehicle includes a track arranged transverse to the airstream. The shutter system also includes a plurality of louvers configured to shift along the track and be guided thereby. The shutter system additionally includes a mechanism configured to select a position for the shutter system between and inclusive of fully-opened and fully-closed to regulate the flow of the incident airstream through the grille opening by shifting the plurality of louvers along the track. Each of the plurality of louvers is arranged along a plane transverse to the incident airstream and remains therein as the position of the shutter system is selected between and inclusive of fully-opened and fully-closed.

Each of the plurality of louvers may be positioned immediately adjacent to the grille opening when the shutter system is fully-closed.

Each of the plurality of louvers may be directly connected to at least one of the remaining plurality of louvers, and be configured to slide relative to the track and to every other one of the plurality of louvers.

Each of the plurality of louvers may partially overlap at least one adjacent louver when the shutter system is fully-closed to thereby provide a seamless blockage of the grille opening.

Each of the plurality of louvers may be connected either to at least one of the remaining plurality of louvers or to the track via a J-hook interlock.

Each of the plurality of louvers may include a feature configured to provide a sliding connection either to at least one of the remaining plurality of louvers or to the track.

The mechanism may include an electric motor and a cable together configured to shift the plurality of louvers along the track.

The shutter system may also include a controller configured to regulate the mechanism.

The vehicle may include an internal combustion engine and the controller may be configured to regulate the mechanism according to a load on the engine.

The engine may be cooled by a fluid circulated through a heat exchanger. In such a case, the vehicle may include a sensor configured to detect a temperature of the fluid and communicate the detected temperature to the controller. Furthermore, the controller may be configured to regulate the mechanism to cool the fluid circulated through the heat exchanger according to the detected temperature of the fluid.

The vehicle may include a bumper beam. Each of the plurality of louvers may be juxtaposed with the remaining plurality of louvers and arranged behind, such as concealed by the bumper beam when the shutter system is fully-opened.

A vehicle employing the shutter system described above is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic side view of a shutter system according to the disclosure, the shutter system being depicted in a fully-closed state.

FIG. 2 is an alternative embodiment of the shutter system shown in FIG. 1, according to the disclosure.

FIG. 3 is a schematic partial side view of a vehicle having the shutter system shown in FIG. 1, the shutter system depicted in a partially closed state.

FIG. 4 is a schematic partial side view of a vehicle having the shutter system shown in FIG. 1, the shutter system depicted in a fully-opened state.

FIG. 5 is a schematic perspective view of the shutter system shown in FIGS. 1-3, the shutter system depicted in the fully-closed state.

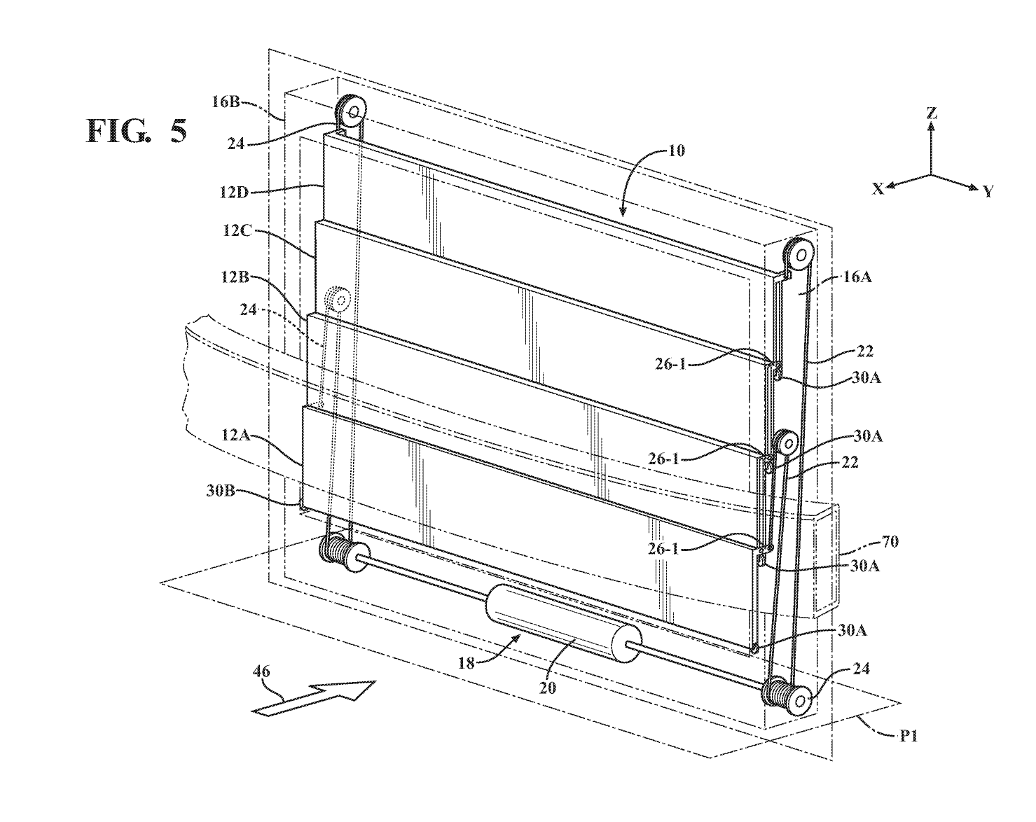

### DETAILED DESCRIPTION

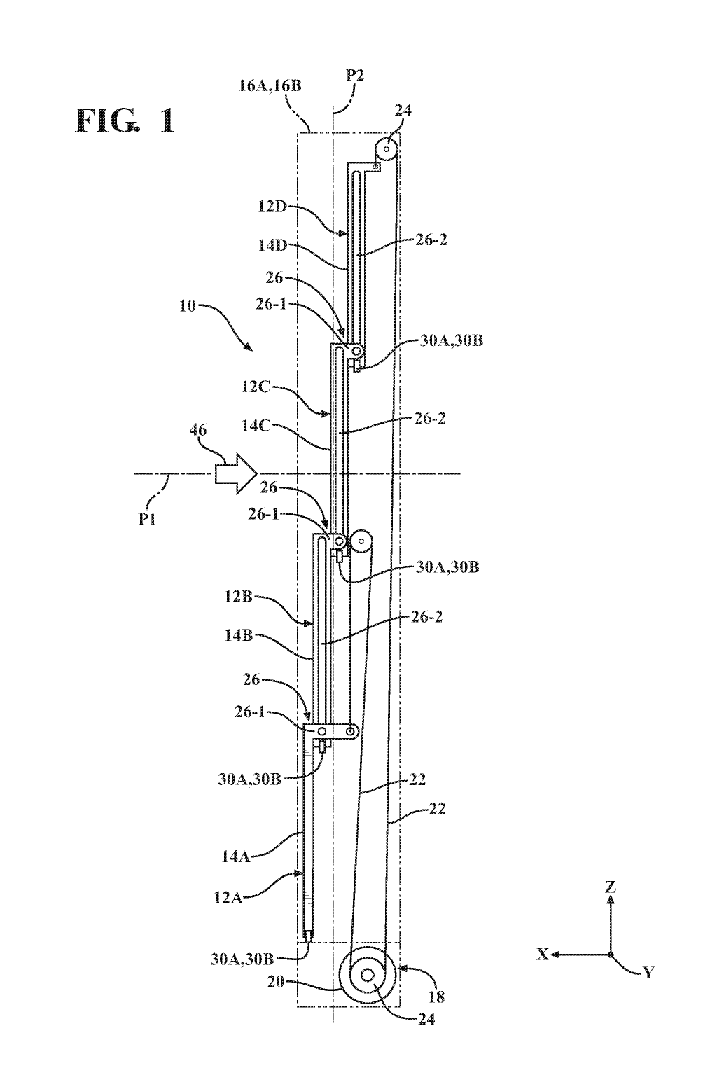

Referring to the drawings, wherein like reference numbers refer to like components, FIG. 1 shows a shutter system 10. Generally, in the Figures, arrangement of the shutter system 10 is depicted with respect to a coordinate system defined by X-Y-Z axes, wherein the X and Y axes together define a horizontal plane P1, and the Z axis defines a vertical direction that is generally perpendicular to the horizontal plane. Although the shutter system 10 can be employed in automotive, as well as other fields, such as in the building and construction industry, for representative purposes, the present disclosure will concentrate on its automotive applications.

As shown in FIG. 1, the shutter system 10 includes a plurality of louvers, herein shown as having four individual louver elements 12A, 12B, 12C, and 12D, but the number of louvers may either be fewer or greater. Each louver 12A-D is characterized by a respective louver face 14A-D and a longitudinal axis Y. The individual louver elements 12A, 12B, 12C, and 12D can be substantially identical in all respects, including the dimensions of respective louver faces 14A-D. The shutter system 10 also includes parallel tracks 16A and 16B generally arranged in a plane P2 that can be transverse or nearly transverse to the horizontal plane P1, e.g., generally parallel or at some acute angle to the vertical axis Z. The louvers 12A-D are arranged to shift along the tracks 16A, 16B and are also guided thereby. Owing to the fact that the louvers 12A-D are arranged on the tracks 16A, 16B, the louvers are also configured to shift along the plane P2, hereinafter referred to as the shutter plane. Each louver 12A-D is moveably connected to the remaining louvers, and is also configured to shift along the tracks 16A, 16B such that each louver remains situated along the shutter plane P2 in every respective position. The shutter system 10 also includes a mechanism 18 configured to select a position for the shutter system between and inclusive of fully-opened and fully-closed by shifting the plurality of louvers along the tracks 16A, 16B.

The mechanism 18 may include an electric motor 20, one or more cables 22, and a respective pulley 24 for each cable. The electric motor 20, the cable(s) 22, and the pulley(s) 24 can be together configured to shift the plurality of louvers 12A-D along the tracks 16A, 16B. Although not shown, the mechanism 18 may also include a geartrain and various levers operatively connected to the electric motor 20 for transmitting torque therefrom for shifting the plurality of louvers 12A-D along the tracks 16A, 16B. The mechanism 18 may be configured to shift the louvers 12A-D in tandem, i.e., substantially in unison, or in some predetermined order and at some predetermined rate for each individual louver relative to the tracks 16A, 16B.

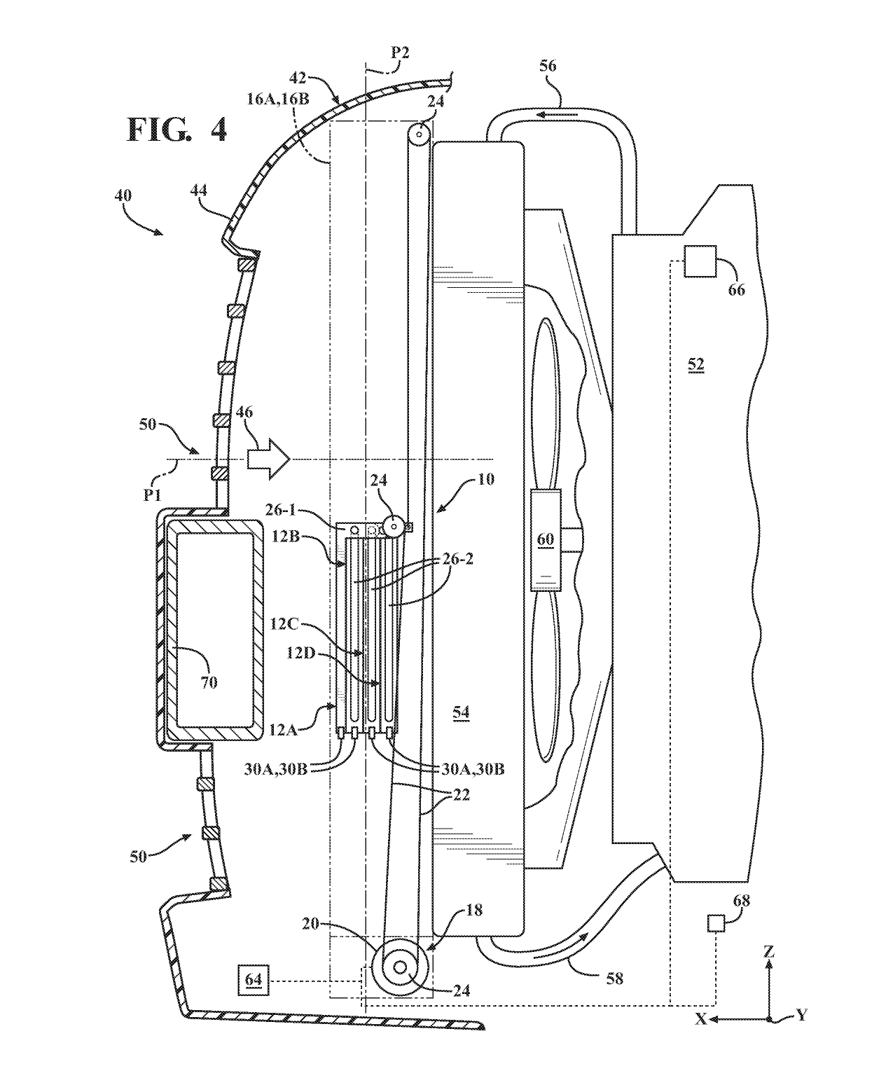

The mechanism 18 acts to select the desired position for the shutter system 10 when activated by an external controller, such as will be discussed in detail below. As shown in FIGS. 1-4, each of the plurality of louvers 12A-D remains arranged along the shutter plane P2 as the shutter system 10 is shifted between and inclusive of the fully-opened and fully-closed positions. Each of the plurality of louvers 12A-D can be directly connected to at least one of the remaining plurality of louvers and be configured to slide relative to the tracks 16A, 16B and to every other one of the plurality of louvers. As shown in FIGS. 1 and 4, each of the plurality of louvers 12A-D partially overlaps at least one adjacent louver when the shutter system 10 is fully-closed.

As shown in FIG. 1, to provide an interconnection between the plurality of louvers 12A-D, each louver can be connected to at least one of the remaining plurality of louvers via an interlock 26 having a J-hook 26-1 and a channel 26-2. Each J-hook 26-1 is configured to extend into the channel 26-2 to thereby interlock two adjacent louvers of the shutter system 10. Additionally, each of the plurality of louvers 12A-D can include a first feature 30A configured to provide a sliding connection to the first track 16A and a second feature 30B configured to provide a sliding connection to the second track 16B. Each of the first and second features 30A, 30B can include a respective projection or a roller having a dedicated bearing surface for reduced friction movement of the louvers 12A-D relative to the tracks 16A, 16B.

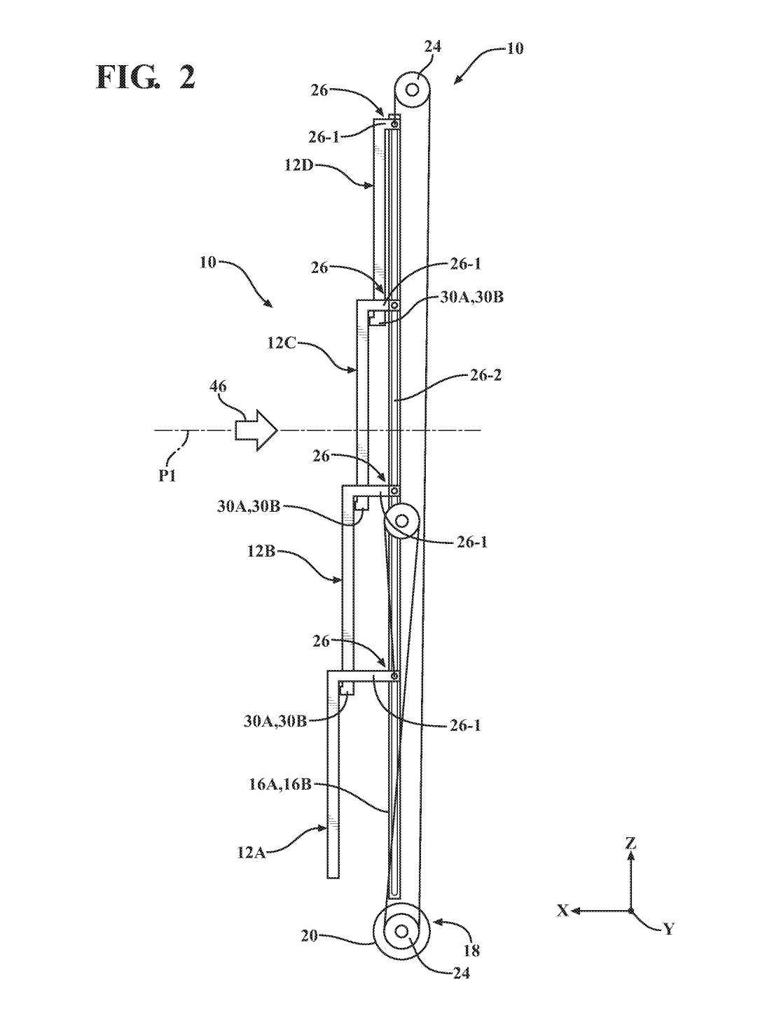

In an alternative embodiment shown in FIG. 2, the interlock 26 can provide an interconnection between the plurality of louvers 12A-D and the first and second tracks 16A, 16B. More specifically, each of the first and second tracks 16A, 16B can include the channel 26-2, while the J-hook 26-1 of each louver 12A-D can extend directly to the respective channels in the first and second tracks. As shown, in such an embodiment the first and second features 30A, 30B can be configured to provide a sliding connection directly between adjacent louvers 12A-D. Additionally, although not specifically shown, each louver 12A-D can employ more than one J-hook 26-1 for engaging each of the first and second tracks 16A, 16B. In such a case, two or more J-hooks 26-1 extending to each of the first and second tracks 16A, 16B can be spaced apart from each other along the Z axis for enhanced stability of the respective louver. Overall, the alternative embodiment can permit a reduced thickness of each individual louver 12A-D and thus generate further reduction in the overall packaging of the shutter system 10 along the longitudinal axis Y.

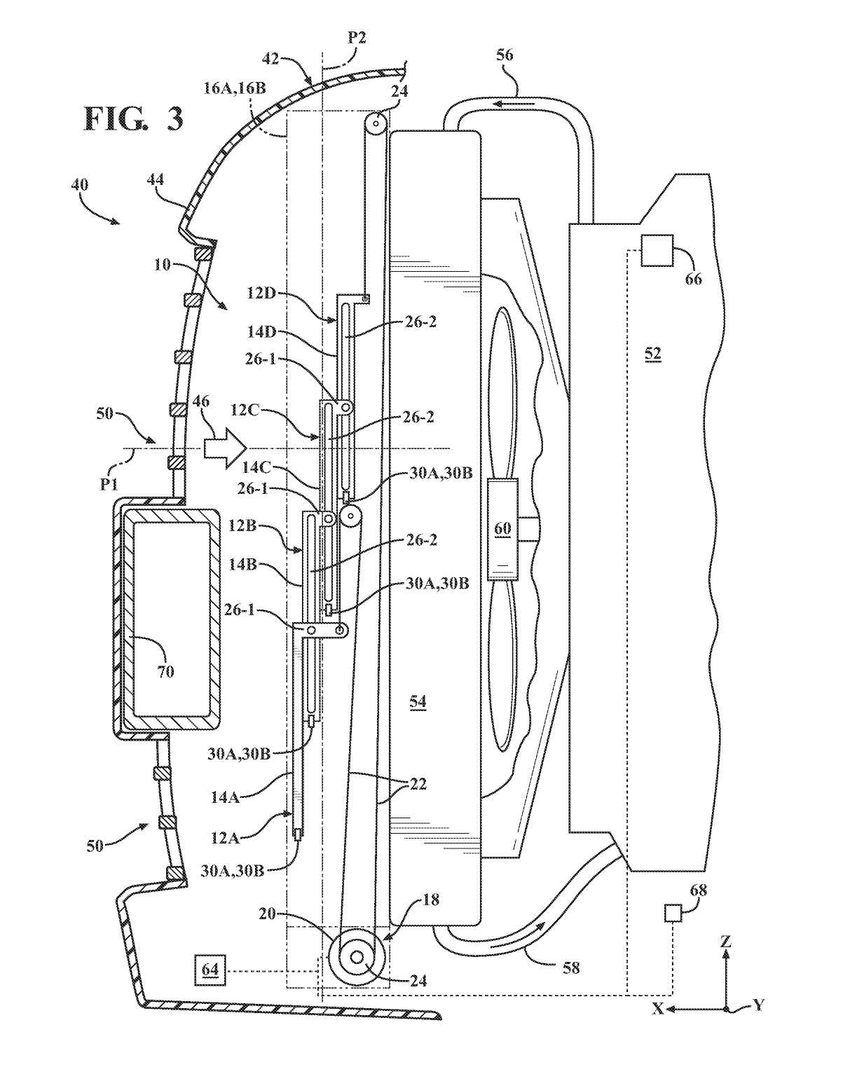

FIGS. 3 and 4 depict the shutter system 10 incorporated inside a vehicle 40. The vehicle 40 includes a vehicle body 42 having a front end 44 configured to face an incident airstream 46 when the vehicle is in motion relative to a road surface (not shown). The front end 44 defines a grille opening 50, which may include a mesh or other guard against airborne debris. The shutter system 10 may be positioned behind the grille opening 50. As shown, the tracks 16A and 16B are arranged generally vertical with respect to the road surface and transverse to the incident airstream 46. As employed herein, the term “transverse” is intended to denote a direction that is cross-wise, i.e., not parallel, to the direction of incident airstream 46, and can be substantially perpendicular thereto. The tracks 16A and 16B can be positioned immediately adjacent to the grille opening 50, such that the plurality of louvers 12A-D is also shifted immediately adjacent to the grille opening.

The mechanism 18 is configured to select a position for the shutter system 10 between and inclusive of fully-opened and fully-closed to regulate the flow of the incident airstream 46 through the grille opening 50 by shifting the plurality of louvers 12A-D along the tracks 16A, 16B. As is shown in FIGS. 1-4, each of the plurality of louvers 12A-D being positioned along the shutter plane P2, is arranged transverse to the incident airstream 46, and remains therein as the position of the shutter system 10 is selected between and inclusive of fully-opened and fully-closed. As shown in FIGS. 1, 2, and 4, because each of the plurality of louvers 12A-D partially overlaps an adjacent louver when the shutter system 10 is fully-closed, the shutter system provides a seamless blockage of the grille opening 50.

The vehicle 40 includes an internal combustion engine 52. As shown, the vehicle 40 includes an air-to-fluid heat exchanger 54, i.e., a radiator, for circulating a cooling fluid, shown by arrows 56 and 58, such as water or a specially formulated coolant, for cooling the engine 52. The heat exchanger 54 is positioned behind the grille opening 50 and behind the shutter system 10 for protection of the heat exchanger from various road- and air-borne debris. The heat exchanger 54 may also be positioned in any other location, such as behind a passenger compartment, if, for example, the vehicle has a rear or a mid-engine configuration, as understood by those skilled in the art.

A fan 60 is positioned behind the heat exchanger 54. The fan 60 may be driven either electrically, or mechanically, directly by the engine 52. The vehicle 40 also includes a controller 64 configured to regulate mechanism 18 for selecting the desired position of the shutter system 10. The controller 64 may include a central processing unit (CPU) configured to regulate operation of the engine 52, as well as other vehicle systems, such as the fan 60, or a dedicated controller for regulating operation of the shutter system 10. In order to appropriately control operation of the shutter system 10, the controller 64 includes a memory, at least some of which is tangible and non-transitory. The memory may be any recordable medium that participates in providing computer-readable data or process instructions. Such a medium may take many forms, including but not limited to non-volatile media and volatile media.

Non-volatile media for the controller 64 may include, for example, optical or magnetic disks and other persistent memory. Volatile media may include, for example, dynamic random access memory (DRAM), which may constitute a main memory. Such instructions may be transmitted by one or more transmission medium, including coaxial cables, copper wire and fiber optics, including the wires that comprise a system bus coupled to a processor of a computer. Memory of the controller 64 may also include a floppy disk, a flexible disk, hard disk, magnetic tape, any other magnetic medium, a CD-ROM, DVD, any other optical medium, etc. The controller 64 can be configured or equipped with other required computer hardware, such as a high-speed clock, requisite Analog-to-Digital (A/D) and/or Digital-to-Analog (D/A) circuitry, any necessary input/output circuitry and devices (I/O), as well as appropriate signal conditioning and/or buffer circuitry. Any algorithms required by the controller 64 or accessible thereby may be stored in the memory and automatically executed to provide the required functionality.

The vehicle 40 additionally includes a coolant sensor 66 configured to detect a temperature of the coolant. The controller 64 is programmed to regulate the mechanism 18 according to a load on the engine 52 and, correspondingly, on the temperature of the coolant detected by sensor 66. Generally, the temperature of the coolant is increased due to the heat produced by the engine 52 under load. As known by those skilled in the art, a load on the engine is typically dependent on operating conditions imposed on the vehicle 40, such as going up a hill and/or pulling a trailer. The load on the engine 52 generally drives up internal temperature of the engine, which in turn necessitates cooling of the engine for desired performance and reliability.

The coolant is routed inside the engine 52 in order to most effectively remove heat from critical engine components, such as bearings (not shown, but known by those skilled in the art). Typically, the employed coolant is continuously circulated by a fluid pump (not shown) between the engine 52 and the heat exchanger 54. In a moving vehicle, the incident airstream 46 at ambient temperature and traveling at a certain velocity with respect to the vehicle penetrates the vehicle's grille opening 50. When the shutter system 10 is open, the incident airstream 46 penetrates the shutter plane P2 of the louvers 12A-D before coming into contact with the heat exchanger 54. As the airstream 46 reaches the heat exchanger 54, the coolant temperature inside the heat exchanger is reduced before the coolant is returned to the engine 52, to thereby cool the engine.

Accordingly, the controller 64 can be configured to regulate the mechanism 18 and adjust position of the plurality of louvers 12A-D to remove heat energy from the coolant circulated through the heat exchanger 54 according to the temperature detected by sensor 66. For example, the controller 64 can be programmed to select the fully-opened position for the shutter system 10 when the sensor 66 detects a temperature of the coolant exceeding a predetermined value. On the other hand, the controller 64 can be programmed to select the fully-closed position for the shutter system 10 when the sensor 66 detects a temperature of the coolant below a predetermined value, such as during a cold start of the engine 52 at below freezing ambient conditions.

At elevated road speeds, efficiency of a typical vehicle is impacted by the vehicle's aerodynamics. The controller 64 can also be configured to regulate the mechanism 18 in response to road speed of the vehicle 40. The road speed of the vehicle 40 can be detected via speed sensors 68, such by detecting rotating speeds of individual road wheels (not shown). For example, the controller 64 can be programmed to select the fully-closed position for the shutter system 10 when the sensors 68 detect a road speed of the vehicle 40 exceeding a predetermined value, thus reducing aerodynamic resistance of the vehicle. The controller 64 can also be programmed to select an intermediate position between the fully-opened and the fully-closed positions for the shutter system 10 when the vehicle 40 is operating below such a predetermined value of the road speed. Such an intermediate position for the shutter system 10 can be selected based on the desired cooling of the engine 52, while simultaneously maximizing overall efficiency of the vehicle 40 by enhancing the vehicle's aerodynamics.

As shown in FIGS. 3 and 4, the vehicle 40 additionally includes a bumper beam 70 positioned at the front end 44. As understood by those skilled in the art, the bumper beam 70 is a force-absorption element mounted to the vehicle body 42. As shown, the bumper beam 70 is positioned ahead of the heat exchanger 54, i.e., such that the airstream 46 contacts the bumper beam prior to reaching the heat exchanger. When the shutter system 10 is fully-opened, as shown in FIG. 4, each of the plurality of louvers 12A-D can be juxtaposed, i.e., positioned side by side, with the remaining plurality of louvers. Furthermore, thus juxtaposed the plurality of louvers 12A-D can also be deposited behind and thereby substantially concealed by the bumper beam 70. Accordingly, the shutter system 10 can be configured such that when the shutter system is fully-opened, none of the louvers 12A-D interfere with the passage of the incident airstream 46 to the heat exchanger 54. Because the louvers 12A-D can be positioned adjacent one another, the overall thickness of the shutter system 10 in its fully-opened state is determined principally by the thickness of the respective louvers. As a result, the shutter system 10 facilitates packaging that is more compact than permitted by typical rotating louver shutters, which are not illustrated in the Figures, but known to those skilled in the art, and can be positioned directly behind the grille opening 50 and immediately in front of the heat exchanger 54. While, primarily for clarity of the shutter system 10 details, the figures depict what may be seen as exaggerated thicknesses of louvers 12A-D, in practice, the thickness of individual louvers can be selected based on specific packaging requirements of the vehicle 40.

When the shutter system 10 is fully-closed, as depicted in FIGS. 1, 2, and 4, the louver faces 14A-D become lined up along and disposed substantially parallel to the tracks 16A, 16B, thus forming a plane of closed louvers. In the fully-closed position of the shutter system 10, each of the louvers 12A-D partially overlaps an adjacent louver to thereby provide a seamless blockage of the airstream 46 at the grille opening 50. A fully-closed shutter system 10 provides optimized aerodynamics for vehicle 40 when engine cooling through the grille opening 50 is not required. On the other hand, when the shutter system 10 is fully-opened, as shown in FIG. 4, each louver 12A-D is shifted to a position behind the bumper beam 70, thus unrestricting access of the airstream 46 through the shutter plane P2. Thus, a fully-opened shutter system 10 is configured to permit a generally unfettered passage of the airstream 46 through the shutter plane P2.

The shutter system 10 may also be regulated by controller 64 to variably restrict access of the oncoming airstream 46 to heat exchanger 54, by shifting louvers 12A-D to an intermediate position, where, as shown in FIG. 3, the louvers are partially closed. An appropriate intermediate position of louvers 12A-D is selected by the controller 64 according to a programmed algorithm to thereby affect the desired cooling of the engine 52. Such an algorithm can be generated based on empirical data or a mathematical model correlating position of the louvers 12A-D with cooling requirements of the engine 52.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. A shutter system for controlling a flow of an incident airstream through a grille opening in a vehicle, the shutter system comprising:
a track arranged transverse to the incident airstream;
a plurality of louvers configured to shift along the track and be guided thereby; and
a mechanism configured to select a position for the shutter system between and inclusive of fully-opened and fully-closed to regulate the flow of the incident airstream through the grille opening by shifting the plurality of louvers along the track;
wherein each of the plurality of louvers is arranged along a plane transverse to the incident airstream and remains therein as the position of the shutter system is selected between and inclusive of fully-opened and fully-closed.

2. The shutter system of claim 1, wherein each of the plurality of louvers is directly connected to at least one of the remaining plurality of louvers.

3. The shutter system of claim 1, wherein each of the plurality of louvers partially overlaps at least one adjacent louver when the shutter system is fully-closed to thereby provide a seamless blockage of the grille opening.

4. The shutter system of claim 1, wherein each of the plurality of louvers is connected either to at least one of the remaining plurality of louvers or to the track via a J-hook interlock.

5. The shutter system of claim 1, wherein each of the plurality of louvers includes a feature configured to provide a sliding connection either to at least one of the remaining plurality of louvers or to the track.

6. The shutter system of claim 1, wherein the mechanism includes an electric motor and a cable together configured to shift the plurality of louvers along the track.

7. The shutter system of claim 1, further comprising a controller configured to regulate the mechanism.

8. The shutter system of claim 7, wherein the vehicle includes an internal combustion engine, and the controller is configured to regulate the mechanism according to a load on the engine.

9. The shutter system of claim 8, wherein:
the engine is cooled by a fluid circulated through a heat exchanger;
the vehicle includes a sensor configured to detect a temperature of the fluid and communicate the detected temperature to the controller; and
the controller is configured to regulate the mechanism to cool the fluid circulated through the heat exchanger according to the detected temperature of the fluid.

10. The shutter system of claim 9, wherein the vehicle includes a bumper beam, and wherein each of the plurality of louvers is juxtaposed with the remaining plurality of louvers and arranged behind the bumper beam when the shutter system is fully-opened.

11. A vehicle comprising:
an internal combustion engine cooled by a circulating fluid;
a heat exchanger configured to cool the fluid via an incident airstream after the fluid cools the engine;
a vehicle body defining a grille opening positioned to permit the incident airstream to pass through on the way to the heat exchanger; and
a shutter system arranged to control a flow of the incident airstream through the grille opening, the shutter system including:
a track arranged transverse to the incident airstream;
a plurality of louvers configured to shift along the track and be guided thereby; and
a mechanism configured to select a position for the shutter system between and inclusive of fully-opened and fully-closed to regulate the flow of the incident airstream through the grille opening by shifting the plurality of louvers along the track;
wherein each of the plurality of louvers is arranged along a plane transverse to the incident airstream and remains therein as the position of the shutter system is selected between and inclusive of fully-opened and fully-closed.

12. The vehicle of claim 11, wherein each of the plurality of louvers is directly connected to at least one of the remaining plurality of louvers.

13. The vehicle of claim 11, wherein each of the plurality of louvers partially overlaps at least one adjacent louver when the shutter system is fully-closed to thereby provide a seamless blockage of the grille opening.

14. The vehicle of claim 11, wherein each of the plurality of louvers is connected either to at least one of the remaining plurality of louvers or to the track via a J-hook interlock.

15. The vehicle of claim 11, wherein each of the plurality of louvers includes a feature configured to provide a sliding connection either to at least one of the remaining plurality of louvers or to the track.

16. The vehicle of claim 11, wherein the mechanism includes an electric motor and a cable together configured to shift the plurality of louvers along the track.

17. The vehicle of claim 11, further comprising a controller configured to regulate the mechanism.

18. The shutter system of claim 17, wherein the vehicle includes an internal combustion engine, and the controller is configured to regulate the mechanism according to a load on the engine.

19. The vehicle of claim 18, further comprising a sensor configured to detect a temperature of the fluid and communicate the detected temperature to the controller, wherein the controller is configured to regulate the mechanism to cool the fluid circulated through the heat exchanger according to the detected temperature of the fluid.

20. The vehicle of claim 19, wherein the vehicle includes a bumper beam, and wherein each of the plurality of louvers is juxtaposed with the remaining plurality of louvers and arranged behind the bumper beam when the shutter system is fully-opened.
